(19) United States
(12) Patent Application Publication
(10) Pub. No.: US 2025/0216879 A1
(43) Pub. Date: Jul. 3, 2025

(54) DLVR System with Duty Cycle Timing Control

(71) Applicant: Taiwan Semiconductor Manufacturing Company, Ltd., Hsinchu (TW)

(72) Inventors: Po-Yu Lai, Hsinchu (TW); Szu-Chun Tsao, Hsinchu (TW)

(21) Appl. No.: 18/402,141

(22) Filed: Jan. 2, 2024

(51) Int. Cl. G05F 1/575; G05F 1/46; G05F 1/595

(52) U.S. Cl. CPC G05F 1/575; G05F 1/468; G05F 1/595

(57) ABSTRACT

Circuits, systems, and methods relating to a digital low-dropout voltage regulator (DLVR) are provided. In an embodiment, a driver array of a DLVR is configured to output a voltage supply to a load, and an analog-to-digital converter is configured to compare the voltage supply to a reference voltage to determine a difference in voltage level between the voltage supply and the reference voltage. A digital controller is connected to the analog-to-digital converter and configured to modulate a gate voltage supplied to the driver array based on the difference in voltage level. Additionally, a duty cycle control module is configured to modify the duty cycle of the gate voltage supplied to the driver array.

### BACKGROUND

In certain integrated circuits and power systems it is desirable to provide a connected load with a steady voltage supply. To do so, a voltage regulator may be provided between a power source and the connected load. Some applications may use a digital low-dropout voltage regulator for this function.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram depicting a digital low-dropout voltage regulator circuit with duty cycle control according to an embodiment.

FIG. 2 is a schematic diagram depicting a power system according to an embodiment.

FIG. 3 is a signal diagram depicting duty cycle control behavior according to an embodiment.

FIG. 4 is a circuit diagram of a DLVR driver and a signal diagram showing an input signal of the circuit according to an embodiment.

FIG. 5 is a table depicting self-heating effect (SHE) penalty and current sourcing capability of a circuit as a function of dropout voltage and duty cycle control according to an embodiment.

FIG. 6 is a schematic diagram depicting a duty cycle control circuit according to an embodiment.

FIG. 7 is a signal diagram depicting signals of a duty cycle control circuit according to an embodiment.

FIG. 8 is a schematic diagram depicting a duty cycle control circuit according to an embodiment.

FIG. 9 is a flowchart depicting a method of operating a digital low dropout voltage regulator circuit.

FIG. 10 is a flowchart depicting a method of regulating a voltage supplied to a load.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in some various examples. This repetition is for the purpose of simplicity and clarity and does not in itself dictate a relationship between some various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Some embodiments of the disclosure are described. Additional operations can be provided before, during, and/or after the stages described in these embodiments. Some of the stages that are described can be replaced or eliminated for different embodiments. Additional features can be added to the circuit. Some of the features described below can be replaced or eliminated for different embodiments. Although some embodiments are discussed with operations performed in a particular order, these operations may be performed in another logical order.

As described above, voltage regulators may be used to deliver a steady voltage supply to a coupled load. In certain power systems, for example, by regulating the voltage supply across individual components (such as processors, AI units, and other digital circuits) of the system, energy efficiency can be improved. To accomplish this, a voltage regulator may be incorporated into a circuit or system.

Voltage regulators may operate by taking an input voltage and producing a different output voltage that matches a desired voltage level. Some voltage regulators are characterized by their dropout voltage, which refers to a difference between input voltage level and output voltage level at which the regulator can no longer properly regulate. Thus, when an input voltage begins to approach the output voltage level, some voltage regulators begin to lose functionality. To provide sufficient regulation in these cases, certain integrated circuits and power systems use digital low-dropout voltage regulators (DLVRs) to control the voltage supply to a coupled load.

In some embodiments, a DLVR comprises a driver array and is configured to receive an input voltage from a power source and pass on an output voltage at a desired level to a connected load. To maintain the output voltage at a steady level, some DLVRs comprise an analog-to-digital converter (A/D) converter and a digital controller to modulate the gate voltage of the driver array. The analog-to-digital converter may receive a reference voltage that has a level set to a voltage level to be supplied to the load. The A/D converter and the controller may be configured to alter the gate voltage of a driver array of the DLVR such that the output voltage of the driver array is substantially equal to the reference voltage. This, in turn, may maintain a steady voltage supply to the load at a specified level. DLVRs are efficient in lower voltage applications, but when connected to a high voltage supply, the dropout voltage may increase, leading to less precise regulation.

In embodiments described herein, a DLVR may be configured for high voltage and speed operations. Additionally, the systems, circuits, and methods described herein may incorporate duty cycle control to dynamically output a control phase to the driver array of the DLVR. As a result, systems, circuits, and methods described herein may reduce the risk of voltage fluctuations (low ΔV), reduce the risk of self-heating effect (SHE), and provide flexible current sourcing capability.

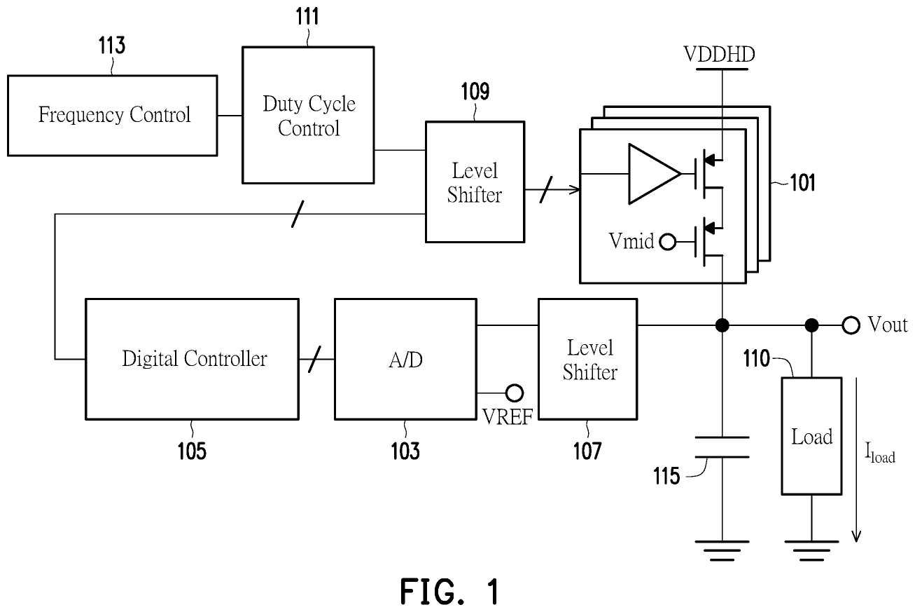

FIG. 1 is a schematic diagram depicting a digital low-dropout voltage regulator (DLVR) circuit with duty cycle control according to an embodiment. In an example circuit, the DLVR may comprise a driver array 101 that is configured to receive at least one input voltage and to supply an output voltage V_{OUT} to a coupled load 110. The driver array 101 may comprise a plurality of transistors. The driver array may comprise a cascode arrangement of its constituent devices.

In some embodiments, the plurality of transistors may comprise a plurality of pairs of transistors wherein the pairs are positioned in parallel. Each pair may comprise a first transistor having a first source/drain coupled to the at least one input voltage, and a second source/drain coupled to a first source/drain of the second transistor of the pair. The first transistor may further comprise a gate coupled to other components of the DLVR as described in more detail below. The second transistor may further comprise a second source/drain that outputs V_{OUT} and is coupled to the load 110. The coupled load may be any type of resistive load including, but not limited to, a processor, an AI unit, or a digital circuit. The second transistor may further comprise a gate coupled to a second input voltage.

In an embodiment, the first transistor and second transistors may be p-type metal-oxide-semiconductor (PMOS) transistors. However, the driver array is not so limited, and may comprise other transistor types in different embodiments. The first PMOS transistor may be coupled to the first input voltage VDDHD, which may be a first, high voltage level. The second PMOS transistor may be coupled the second input voltage VMID which may be a second voltage level that is lower than the first. In an embodiment, the first input voltage may represent the input/output (IO) voltage domain of a power system. Splitting the input voltage into a high voltage IO domain and a lower core voltage domain may allow for the DLVR to be used in both high voltage and high speed applications.

The circuit may further comprise an analog-to-digital converter 103 and a digital controller 105. The analog-to-digital converter 103 may have a first input that receives a reference voltage VREF. This reference voltage may set to a particular voltage level that allows for a desired voltage level to be supplied to the load 110. A/D converter 103 is also connected to the output voltage of the driver array V_{OUT} through a first level shifter 107. Together with digital controller 105 A/D converter 103 may control a gate voltage applied to transistors of the driver array 101 so as to generate the output voltage V_{OUT} at a desired voltage level. The A/D converter 103 may compare the output voltage to the reference voltage and pass a signal to digital controller 105. The digital controller 105 may determine a difference between the output voltage and the reference voltage and may apply a digital algorithm to determine how to modulate the voltage applied to the driver array. Signals from the digital controller 105 to the driver array 101 may be passed through a second level shifter 109.

In an embodiment, the DLVR further comprises a duty cycle control module 111 connected to frequency control module 113. The frequency control module 113 may comprise any clock source capable of supplying a relying frequency including, but not limited to, a ring oscillator. Duty cycle control module 111 may control the ON/OFF switching of the driver array 101. The DLVR may also include a capacitor 115 in parallel with the coupled load 110. By controlling ON/OFF of the driver array 101, duty cycle control implementations of the embodiments described herein may lower the risks of voltage fluctuation and overheating.

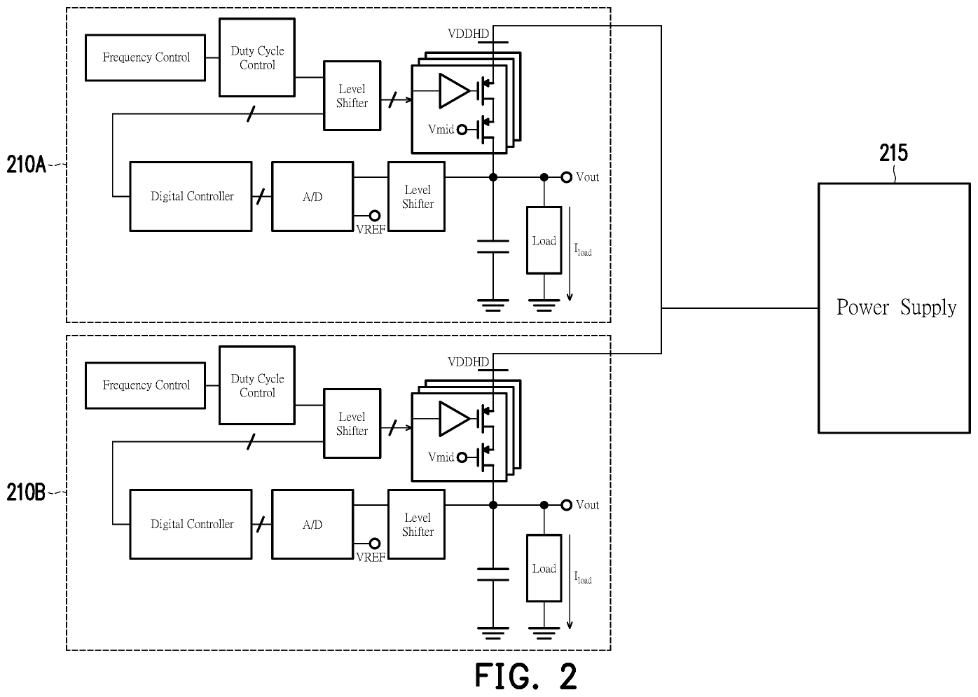

FIG. 2 is a schematic diagram depicting a power system according to an embodiment. DLVRs 210A and 210B may be incorporated into the power system, and these DLVRs may be similar to those described above with reference to FIG. 1. In an embodiment, the power system is a high voltage power system. As shown in FIG. 2, the power system may comprise a power supply 215. The power supply may be configured to supply a current to a plurality of loads within the power system so as to power the plurality of loads. For example, each load may comprise a processor, AI unit, or other digital circuit of the system, and the power supply 215 may be configured to supply each of these with operating current. In order to optimize power usage through the system, each load may be coupled to a particular DLVR circuit (e.g., a DLVR dedicated to that load) connected between the load and the power supply. While FIG. 2 shows two DLVR circuits connected to power supply 215, it will be appreciated that the power supply may be coupled to any number of DLVRs.

The power supply 215 may supply an IO voltage and a core voltage. The IO voltage may be higher than the core voltage. The high voltage power system may split the core voltage domain from the IO voltage domain. This may allow for the core voltage to be supplied for high speed calculations, while allowing the IO voltage supply to be used in high voltage applications. The high speed calculations using core voltage may be used to monitor the power system and ensure proper distribution and performance. The high voltage applications using IO voltage may comprise providing the IO voltage as high voltage signal VDDHD to the driver arrays of DLVRs of the power system. As further described below, the risks of applying the high (IO) voltage to the driver array of DLVRs may be offset by the duty cycle control solutions of embodiments described herein.

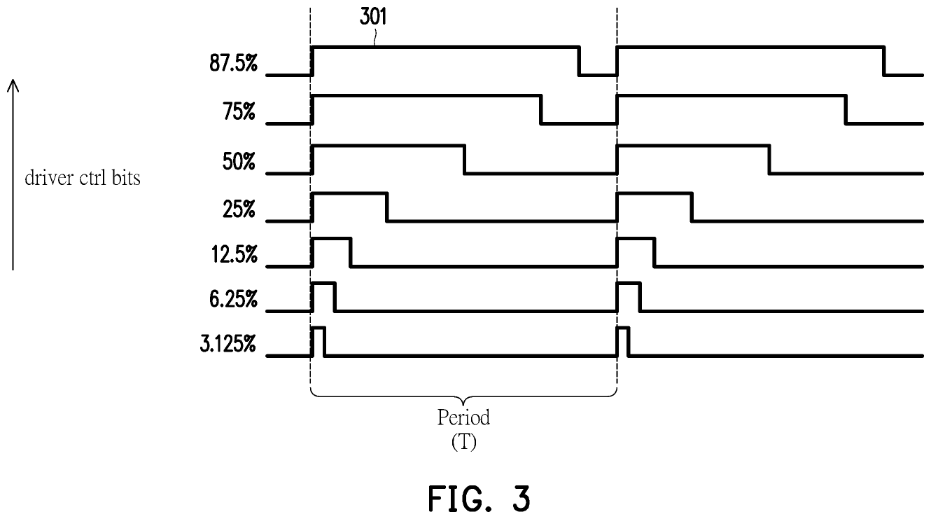

FIG. 3 is a signal diagram 301 depicting duty cycle control behavior according to an embodiment. The duty cycle control system according to embodiments may adjust the proportion of time that the gate signal is ON during a period T (referred to at some points herein as the “ON percentage,” or alternately as the “duty cycle” of the signal). The signal period may be controlled by the frequency control module 113.

In an embodiment, duty cycle control can be implemented with binary weighting. As the number of driver control bits that are turned on increases, the proportion of time the signal is turned on also increases. Signal diagram 301 shows the duty cycle (ON percentage) along the y-axis, and the width of the modulated pulse along the x-axis. Binary weighting control may allow for precise, fine-grained control of the duty cycle. In an example binary phase splitting according to an embodiment, the duty cycle can be split into the following levels: 3.125%; 6.25%; 12.5%; 25%; 50%; 75%; and 87.5% by turning on or off individual diver control bits. This precise duty cycle control may lower the risk of voltage fluctuation and minimize SHE penalty.

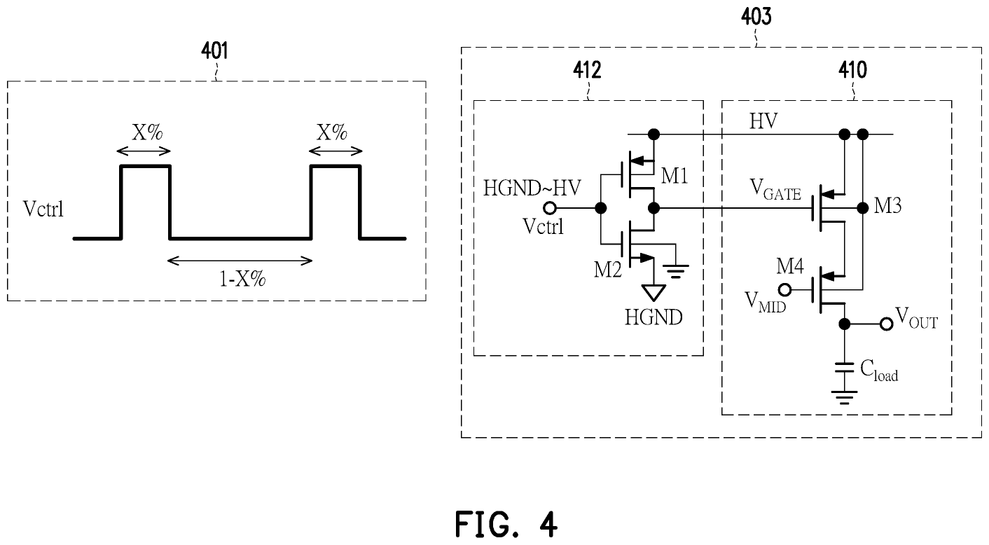

FIG. 4 is a circuit diagram of a DLVR driver array and a signal diagram showing an input signal of the circuit according to an embodiment. As shown in circuit diagram 403, a DLVR driver array may comprise a DLVR driver circuit 410 and a high voltage pre-driver circuit 412. DLVR driver circuit 410 may be similar to the DLVR driver array described above with reference to FIG. 1, and may comprise a pair of transistors M3, M4 connected between a high voltage input HV and an output voltage V_{OUT}. Transistors M3 and M4 may comprise PMOS transistors. A gate of transistor M4 may be connected to a voltage VMID and a gate of transistor M3 may receive a voltage signal from the high voltage pre-driver circuit, as described in greater detail below.

High voltage pre-driver circuit 412 may also comprise a pair of transistors M1, M2. These transistors may comprise a PMOS transistor M1 and an N-type metal-oxide-semiconductor (NMOS) transistor M2. PMOS transistor M1 may have a first source/drain connected to a high voltage rail HV and a second source/drain connected to a first source/drain NMOS transistor M2. Transistors M1 and M2 may each comprise a gate that is coupled to an input voltage V_{CTRL}. In an embodiment, the input voltage V_{CTRL} may be a signal that is modulated by a digital controller and a duty cycle control module as described above with respect to FIG. 1. The input voltage V_{CTRL} may be passed to the high voltage pre-driver circuit 412 from a level shifter in the DLVR circuit. The transistors M1 and M2 may be arranged as a complimentary metal-oxide-semiconductor (CMOS) transistor. The high-voltage pre-driver circuit 412 may receive the input voltage V_{CTRL} and passes an output voltage V_{GATE} to the first transistor M3 of the DLVR driver circuit. Transistor M2 of the high voltage pre-driver circuit 412 may also be connected to a high-side ground terminal HGND.

Input voltage V_{CTRL} may be modulated by a duty cycle control module as described above. Signal diagram 401 shows pulsing of the input voltage V_{CTRL} as set by a duty cycle control module. This pulsed signal may be passed to the high voltage pre-driver circuit 412, which may then further modulate the voltage applied to the DLVR driver circuit 410. DLVR driver circuits with pre-driver according to embodiments may provide a lower risk of fluctuations in the output voltage, and the dynamic duty cycle control may lower stress the driver array and decrease the impact of self-heating effects (SHE).

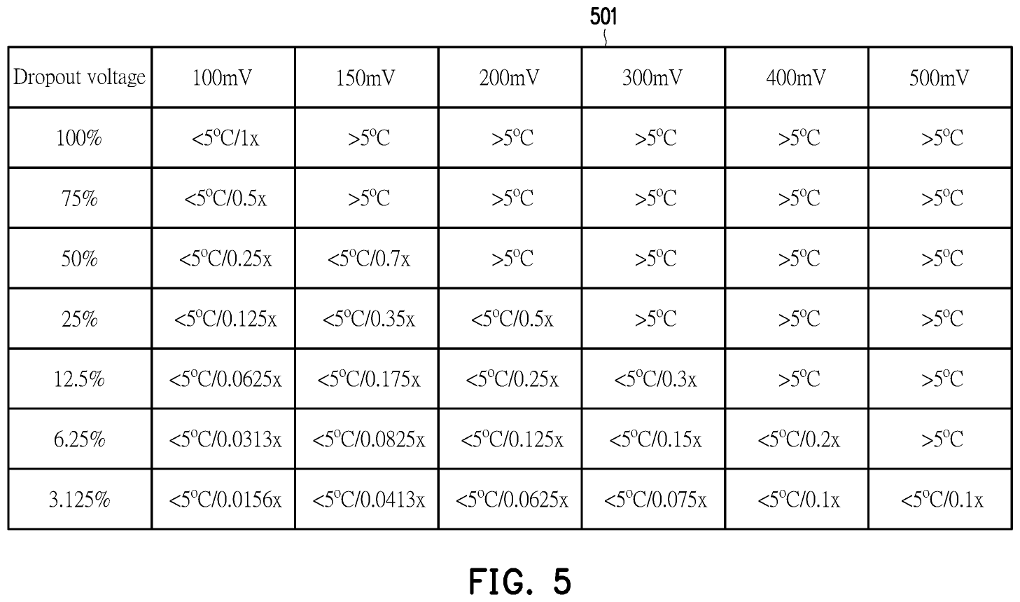

FIG. 5 is a table 501 depicting SHE penalty and current sourcing capability of a circuit as a function of dropout voltage and duty cycle control according to an embodiment. In table 501, the first column depicts an ON percentage of an input voltage as provided by duty cycle control mechanisms described above. The first row depicts the dropout voltage of a DLVR according to embodiments. Each box shows the SHE penalty and current sourcing capability that may arise according to the associated duty cycle control and dropout voltage. SHE penalty is expressed by the rise in temperature and the current sourcing capability is expressed as a proportion of the maximum current that the device could be delivered to the load.

Embodiments described herein may allow for reduced SHE penalty through dynamic duty cycle control in order to optimize current sourcing capability. For example, a SHE penalty of less than 5° C. In general, as dropout voltage increases, SHE penalty may also increase. As the table shows, in order to offset this, duty cycle control may be employed such that DLVRs may be provided that operate at higher dropout voltages without a SHE penalty of over 5° C.

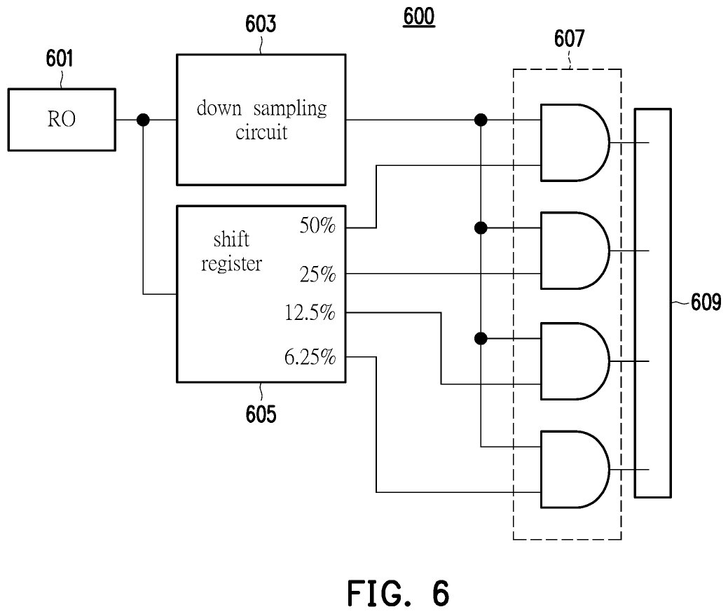

FIG. 6 is a schematic diagram depicting a duty cycle control circuit according to an embodiment. In an embodiment, duty cycle control circuit 600 may comprise a digital phase control circuit with a shift register. For example, duty cycle control may comprise a ring oscillator 601, a down sampling circuit 603, a shift register 605, and a plurality of logic gates 607. Reference numeral 609 represents an output of the duty cycle control circuit 600 and may comprise a different voltage level depending on the selected duty cycle.

In an embodiment, the ring oscillator 601 may operate as a frequency controller and set a frequency of a signal that is input to the down sampling circuit 603 and shift register 605. Logic gates 607 may comprise AND gates. During operation, the down sampling circuit may output a signal having a reduced period from that of the input signal from the ring oscillator 601. The output of the down sampling circuit is supplied to one input terminal of each logic gate of the plurality of logic gates. Shift register 605 may comprise a plurality of outputs, each associated with a particular binary weight (e.g. 6.25%, 12.5%, 25%, 50% as shown in FIG. 6). Each output of shift register 605 may be connected to a second input of a particular AND gate. The plurality of logic gates 607, in turn, may pass output signals along to the duty cycle control circuit output 609 based on the applied input signals.

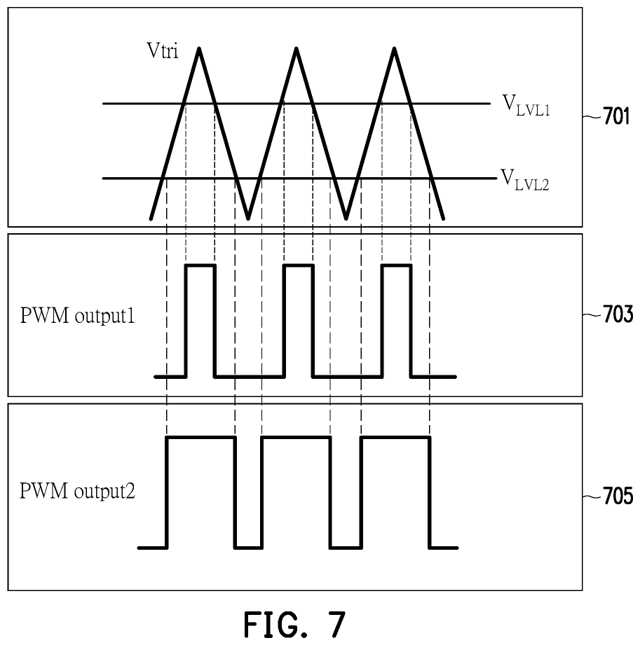

FIG. 7 is a signal diagram depicting a duty cycle control system according to an embodiment. In an embodiment duty cycle control can be implemented by an analog phase control circuit with pulse width modulation. For example, the analog phase control circuit may comprise one or more comparators that compare an input triangular wave signal V_{TRI} to desired voltage levels V_{LVL1}, V_{LVL2}.

The signal diagram includes a first section 701 that depicts the triangular wave signal V_{TRI} along with the two voltage levels. As shown, as the signal climbs from a minimum value to a maximum value it passes through both V_{LVL1} and V_{LVL2}. The signal does the same as it descends from a maximum to a minimum. A duty cycle control system according to embodiments may use these as threshold voltages to generate pulses having widths corresponding to the period in which the level of the triangular wave signal is above the level of the V_{LVL1} and V_{LVL2}. Second section 703 depicts a first pulse width modulation output that sets a pulse width for the period when the signal is above V_{LVL1}. Third section 705 depicts a second pulse width modulation output that sets a pulse width for the period when the signal is above V_{LVL2}.

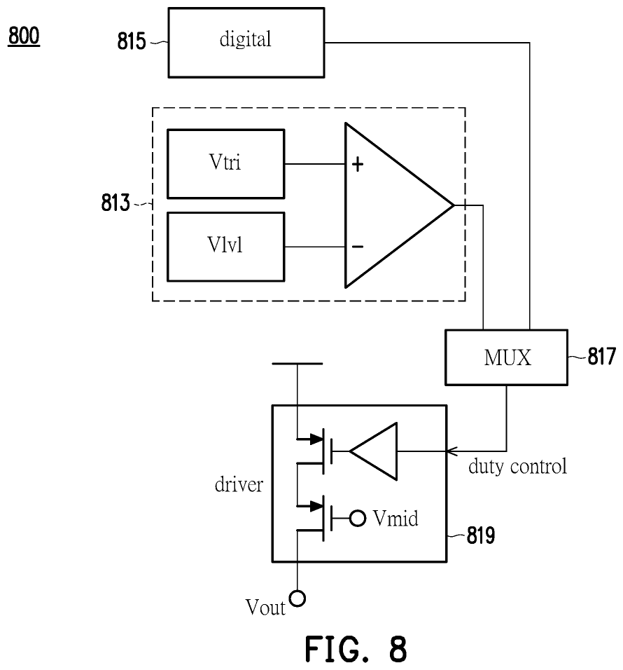

FIG. 8 is a schematic diagram depicting a duty cycle control circuit 800 according to an embodiment. In an example circuit, the duty cycle control circuit 800 may comprise both a digital phase control circuit 815 and an analog phase control circuit 813. Digital phase control circuit 815 may comprise components similar to those described above with respect to FIG. 6. Analog phase control circuit 813 may comprise a comparator, and may operate in a manner similar to that described above with respect to FIG. 7. Phase control may be switched between digital and analog control by a multiplexer (MUX) 817. The duty cycle control circuit may then pass a duty control signal to the driver of a DLVR 819 in order to supply a steady, regulated output voltage V_{OUT}.

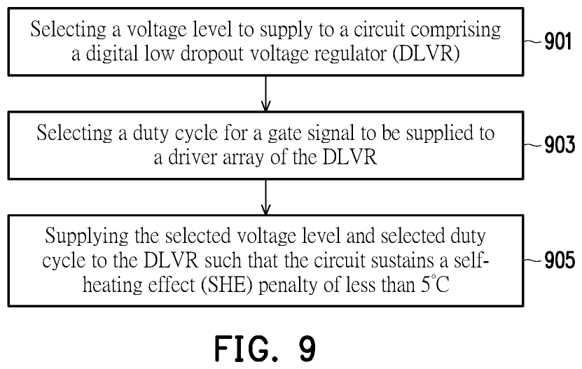

FIG. 9 is a flowchart depicting a method of operating a digital low dropout voltage regulator circuit, according to an embodiment. The method may begin 901 by selecting a voltage level to supply to a circuit comprising a DLVR. For example, the circuit may be a circuit as described above with reference to FIG. 1. The DLVR may be configured to receive the input voltage supply from a power supply and to pass an output voltage to the connected load.

In an embodiment, the DLVR circuit may be operated under high voltage, and consequently a high dropout voltage. However, operating under high voltage may cause undesired self-heating effects. To mitigate this, the duty cycle control module may be provided and may be configured to control a duty cycle (ON percentage) of a gate signal supplied to the DLVR.

To optimize performance, at 903 a duty cycle for a gate signal to be supplied to a driver array of the DLVR is also selected. The value of the voltage supply and the duty cycle may be selected so as to avoid undesired (SHE) penalties.

At 905, the method supplies the selected voltage level and selected duty cycle to the DLVR in order to operate the circuit at a level that avoids SHE penalties. In an embodiment, the values may be selected such that any SHE penalty sustained is less than 5° C. The values may be selected according to the data presented and described above with reference to FIG. 5. For example, the input voltage may be selected such that the dropout voltage is 200 mV and the ON percentage may be selected to be 12.5%, thereby avoiding a SHE penalty of over 5° C.

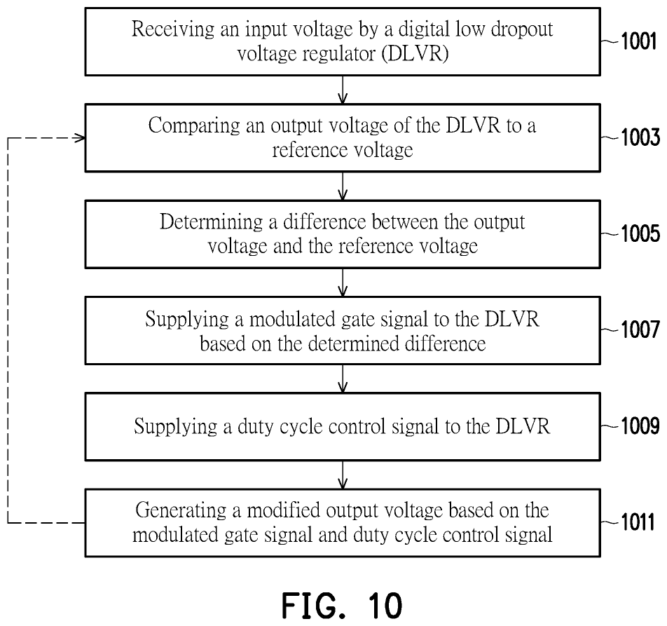

FIG. 10 is a flowchart depicting a method of regulating a voltage supplied to a load, according to an embodiment. An example method may begin at 1001 by receiving an input by a digital low dropout voltage regulator (DLVR). A driver array, for example the driver array 101 as described above with reference to FIG. 1, of the DLVR may receive this voltage as an input and may generate an output voltage to be passed on to a coupled load. The method proceeds at 1003 by comparing an output voltage of a DLVR to a reference voltage. In an embodiment DLVR may be incorporated into circuit as shown in FIG. 1 and described above. The comparison of 1001 may be made analog-to-digital converter 103 by comparing V_{OUT} from the driver array 101 with a reference voltage VREF.

The method may then proceed to 1005 and a digital controller 105 may determine a difference between V_{OUT} and VREF. As shown in FIG. 1, the digital controller 105 may be connected to the driver array 101 through a level shifter 109. Based on the determined difference, the digital controller 105 may supply a modulated gate signal to the driver array 101 of the DLVR at 1007.

The circuit may also comprise a duty cycle control module 111 which may also be connected to the driver array 101 through level shifter 109. The duty cycle control module 111 may supply a duty cycle control signal to the DLVR at 1009.

The method may then proceed to 1011 and, based on the received modulated gate signal and duty cycle control signal, the DLVR may generate a modified output voltage. This modified output voltage may then be supplied to the connected load. This signal will also be compared to VREF by the analog-to-digital converter, and they cycle may repeat as indicated by the dashed line in FIG. 10. This method may allow for the output voltage V_{OUT} to be substantially equal to a desired voltage for the connected load, thereby increasing efficiency of the system.

Circuits, systems, and methods are described herein. In an example circuit, a driver array comprising a plurality of transistors is configured to output a voltage supply. The circuit further comprises an analog-to-digital converter configured to compare the voltage supply to a reference voltage to determine a difference in voltage level between the voltage supply and the reference voltage, a digital controller connected to the analog-to-digital converter and configured to modulate a gate voltage supplied to the driver array based on the difference in voltage level, and a duty cycle control module configured to modify the duty signal of the gate voltage supplied to the driver array.

In an example system, a power supply configured to supply an input/output (IO) voltage and a core voltage is connected to a digital low dropout voltage regulator (DLVR). In the system, the DLVR is configured to receive a high voltage input from the power supply and deliver an output voltage. The high voltage input is the IO voltage and the power supply is configured to supply the core voltage to perform calculations.

In an example method of operating a circuit, a driver array of a digital low dropout voltage regulator (DLVR) receives an input voltage generates an output voltage. This output voltage is compared to a reference voltage and a difference between the output voltage and the reference voltage is determined. A modulated gate signal is supplied to the driver array of the DLVR based on this determined difference. A duty control signal is also supplied to the driver array of the DLVR and a modified output voltage is generated based on the modulated gate signal and duty control signal.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

It is claimed:

1. A digital low-dropout voltage regulator (DLVR) circuit comprising:
a driver array configured to output a voltage supply, wherein the driver array comprises a plurality of transistors;
an analog-to-digital converter configured to compare the voltage supply to a reference voltage to determine a difference in voltage level between the voltage supply and the reference voltage;
a digital controller configured to modulate a gate voltage supplied to the driver array based on the difference in voltage level; and
a duty cycle control module configured to modify the duty cycle of the gate voltage supplied to the driver array.

2. The circuit of claim 1, further comprising:
a frequency control module connected to the duty cycle control module, wherein the frequency control module comprises a ring oscillator.

3. The circuit of claim 1, wherein the gate voltage is a first gate voltage; and
wherein plurality of transistors comprises a first transistor comprising a first source/drain connected to a high voltage signal and a first gate configured to receive the first gate voltage; and
a second transistor comprising a second gate configured to receive a second gate voltage having, wherein the second gate voltage level is lower than the high voltage signal voltage level.

4. The circuit of claim 1, wherein the analog-to-digital controller is connected to the driver array through a first level shifter; and
the digital controller and the duty cycle control module are connected to the driver array through a second level shifter.

5. The circuit of claim 4, wherein the driver array comprises a DLVR driver circuit and a high voltage pre-driver circuit.

6. The circuit of claim 5, wherein the high voltage pre-driver circuit receives an input voltage from the second level shifter and outputs the gate voltage to a first transistor of the DLVR driver circuit.

7. The circuit of claim 1, wherein the duty cycle control module comprises a digital phase control circuit.

8. The circuit of claim 7, wherein the digital phase control circuit comprises a down sampling circuit and a shift register configured to receive a frequency input from a ring oscillator.

9. The circuit of claim 1, wherein the duty cycle control module comprises an analog phase control circuit.

10. The circuit of claim 9, wherein the analog phase control circuit comprises a comparator configured to provide pulse width modulation.

11. The circuit of claim 1, wherein the duty cycle control module comprises a digital phase control circuit and an analog phase control circuit.

12. The circuit of claim 11, further comprising a multiplexer connected to the digital phase control circuit and the analog phase control circuit and configured to switch the duty cycle control module between the digital phase control circuit and the analog phase control circuit.

13. A power system, comprising:
a power supply configured to supply an input/output (IO) voltage and a core voltage; and
a digital low dropout voltage regulator (DLVR) configured to receive a high voltage input from the power supply and generate an output voltage,
wherein the high voltage input is the IO voltage and the power supply is configured to supply the core voltage to perform calculations.

14. The power system of claim 13, wherein the DLVR is a first DLVR of a plurality of DLVRs; and
the power supply is connected to each DLVR of the plurality of DLVRs.

15. The power system of claim 13, wherein the system further comprises a processor, an AI unit, or a digital circuit; and
the processor, AI unit, or digital circuit is configured to receive the output voltage.

16. The power system of claim 13, wherein the DLVR comprises a duty cycle control module.

17. A method of operating a circuit, comprising:
receiving an input voltage by a digital low dropout voltage regulator (DLVR),
wherein a driver array of the DLVR takes the input voltage as an input and generates an output voltage;
comparing the output voltage to a reference voltage;
determining a difference between the output voltage and the reference voltage;
supplying a modulated gate signal to the driver array of the DLVR based on the determined difference;
suppling a duty cycle control signal to the driver array of the DLVR; and
generating a modified output voltage based on the modulated gate signal and duty cycle control signal.

18. The method of claim 17, wherein the input voltage and duty cycle control signal are selected such that the circuit sustains a self-heating effect (SHE) penalty of less than 5° C.

19. The method of claim 17, wherein the input voltage is a high voltage supply.

20. The method of claim 17, wherein the supplying a duty cycle control signal is controlled with a binary weighting process comprising selecting a number of driver control bits to be in an ON state.
